(19) United States
(12) Patent Application Publication
(10) Pub. No.: US 2026/0130391 A1
(43) Pub. Date: May 14, 2026

(54) METHOD FOR DEBITTERIZING WHEAT PROTEIN PEPTIDE RESIDUE

(71) Applicant: Suzhou University, Suzhou (CN)

(72) Inventors: Kun Yao, Suzhou (CN); PeiLin Yao, Suzhou (CN); Xiao Wu, Suzhou (CN); Na Li, Suzhou (CN)

(21) Appl. No.: 19/304,579

(22) Filed: Aug. 19, 2025

(30) Foreign Application Priority Data
Nov. 12, 2024 (CN) 202411609579.1

(51) Int. Cl. A23J 3/18; A23J 3/34; A23L 5/20

(52) U.S. Cl. CPC A23J 3/18; A23J 3/346; A23L 5/25; A23L 5/273

(57) ABSTRACT

A method for debitterizing wheat protein peptide residue (WPPR) includes steps S1-S5. S1, the wheat protein peptide residue are taken to crush, and then deionized water are added into the crushed WPPR to obtain the peptide residue solution; S2, debitterizing modified solution is added to the peptide residue solution (PRS), and the PRS is filtered to obtain a preliminarily modified peptide residue solution (PMPRS); S3, modified flavor protease is added to the PMPRS, stirred and heated in a water bath to obtain a debitterized peptide residue (DPR) solution; S4, a supernatant of the debitterized peptide residue solution is removed to obtain a remaining solution, and the remaining solution is poured into a centrifuge tube to centrifugate to obtain a peptide residue precipitate; and S5, supercritical carbon dioxide extraction is performed on the peptide residue precipitate, and freeze-dried to obtain a final debitterized peptide residue product.

### CROSS-REFERENCE TO RELATED APPLICATION

This application claims priority to Chinese Patent Application No. 202411609579.1, filed on Nov. 12, 2024, which is herein incorporated by reference in its entirety.

### TECHNICAL FIELD

The disclosure relates to technical field of wheat debitterization, and particularly to a method for debitterizing wheat protein peptide residue.

### BACKGROUND

Wheat protein powder has a high protein content of up to 75%-85%, and contains all 15 essential amino acids required by the human body. It is a nutritionally rich plant protein resource with properties such as viscosity, elasticity, extensibility, film-forming ability, and lipid absorption. Wheat protein peptides are small-molecule peptides obtained from wheat protein powder using various enzyme preparations through targeted enzymatic hydrolysis and specific peptide separation technologies. They are characterized by good water solubility, stable dispersion, easy absorption, and strong biological activity. Due to their excellent emulsifying and water-holding capabilities, the wheat protein peptides are widely used in various industries, such as feed production, cosmetics, baking, functional protein beverages and dairy products, seasonings, noodle products, and healthcare. However, during a production of the wheat protein peptides, a large amount of wheat protein peptide residue containing bitter components is often generated. These bitter components mainly originate from the off-flavor substances in wheat and by-products of the enzymatic hydrolysis process, which severely limit their direct utilization and market acceptance. Existing wheat debitterization technologies often suffer from low efficiency, high cost, and the potential to affect the nutritional components of the product or introduce harmful substances.

### SUMMARY

In view of the deficiencies of the related art, the objective of the disclosure is to provide a method for debitterizing wheat protein peptide residue. In the disclosure, a peptide residue solution is preliminarily debitterized through a debitterizing modified solution, peptide bonds within the peptides of the wheat protein peptide residue can be cleaved through endopeptidases of composite flavor protease, thereby degrading long-chain peptides into shorter peptide segments. Among these short-chain peptides, some contain hydrophobic amino acids, and these peptide segments are often the source of bitterness. Exopeptidases are responsible for sequentially cleaving and releasing amino acids from the ends of the peptide chains. In this method, the exopeptidases can further degrade the bitter peptides into individual amino acids, thereby effectively eliminating the bitterness.

To achieve above propose, the technical solutions of the disclosure are provided as follows.

A method for debitterizing wheat protein peptide residue includes steps as follows:
S1, a peptide residue solution is prepared: 1-3 parts by weight of the wheat protein peptide residue are taken to crush for 10 minutes (min) to 15 min to obtain crushed wheat protein peptide residue, and 15-25 parts by weight of deionized water are added into the crushed wheat protein peptide residue to obtain the peptide residue solution;
S2, 15-25 parts by weight of debitterizing modified solution are added to the peptide residue solution, and the peptide residue solution added with the debitterizing modified solution is filtered to obtain a preliminarily modified peptide residue solution;
S3, 5-8 parts by weight of modified flavor protease are added to the preliminarily modified peptide residue solution, the preliminarily modified peptide residue solution added with the modified flavor protease is stirred to obtain a stirred solution, the stirred solution is heated in a water bath at 30 Celsius degrees (° C.) to 40° C. for 1 hour (h) to 3 h to obtain a debitterized peptide residue solution, and a potential of hydrogen (pH) of the debitterized peptide residue solution is adjusted to 6-8;
S4, a supernatant of the debitterized peptide residue solution is removed to obtain a remaining solution by using a separatory funnel, and the remaining solution is poured into a centrifuge tube, and the centrifuge tube with the remaining solution is placed on a centrifuge to centrifugate for 5 min to 15 min, thereby obtaining a peptide residue precipitate; and
S5, supercritical carbon dioxide extraction is performed on the peptide residue precipitate to obtain an extracted peptide residue precipitate, and the extracted peptide residue precipitate freeze-drying to obtain a final debitterized peptide residue product by using a lyophilizer.

A preparation method of the debitterizing modified solution includes steps as follows:
S201, 0.5-1 parts by weight of yeast, 0.1-0.2 parts by weight of active dry brewing yeast, 8-10 parts by weight of deionized water, and 2-3 parts by weight of propanol solution are mixed and stirred to obtain a first mixture, and 0.2-1 parts by weight of sodium dihydrogen phosphate are added into the first mixture to obtain a primary modified solution; and
S202, 4-5 parts by weight of activated carbon are added to the primary modified solution to stir thoroughly, thereby obtaining the debitterizing modified solution.

In an embodiment, a preparation method of the modified flavor protease includes steps as follows:
S301, Lactiplantibacillus plantarum is inoculated onto a first culture medium, and the first culture medium inoculated with the Lactiplantibacillus plantarum is incubated in a constant temperature incubator at 35° C. to 37° C. for 10 h to 12 h to obtain incubated Lactiplantibacillus plantarum. The incubated Lactiplantibacillus plantarum from a slant of the first culture medium is selected, and the incubated Lactiplantibacillus plantarum is inoculated into a sterilized De Man, Rogosa and Sharpe (MRS) liquid culture medium to incubate in the constant temperature incubator at 35° C. to 37° C. for 10 h to 12 h to obtain a Lactiplantibacillus plantarum seed solution;
S302, Bacillus subtilis is inoculated onto a second culture medium, and the second culture medium inoculated with the Bacillus subtilis is incubated in the constant temperature incubator at 35° C. to 37° C. for 10 h to 12 h. A loop of bacterial lawn of the Bacillus subtilis from a slant of the second culture medium with incubated Bacillus subtilis is selected, the loop of bacterial lawn of the Bacillus subtilis is inoculated onto a shake flask seed culture medium for shaking culture at 35° C. to 37° C. for 10 h to 12 h to obtain a Bacillus subtilis seed solution; and
S303, 10-15 parts by weight of composite flavor protease, 1.5-4 parts by weight of the Lactiplantibacillus plantarum seed solution, and 1-3 parts by weight of the Bacillus subtilis seed solution are mixed to obtain a second mixture, and the second mixture is placed in a constant temperature shaker for fermentation culture for 8 h to 10 h to obtain the modified flavor protease.

In an embodiment, in the step S301, the first culture medium is a MRS solid agarslantculture-medium.

In an embodiment, in the step S302, the second culture medium is a Luria-Bertani (LB) solid agarslantculture-medium.

In an embodiment, in the step S302, a rotational speed of the shaking culture is in a range of 120 revolutions per minute (rpm) to 150 rpm.

In an embodiment, a temperature of the constant temperature shaker is in a range of 35° C. to 37° C., and a rotational speed of the constant temperature shaker is in a range of 150 rpm to 200 rpm.

In an embodiment, a time of the stirring is in a range of 20 min to 25 min, and a rotational speed of the stirring is in a range of 350 rpm to 450 rpm.

In an embodiment, in the step S4, a rotational speed of the centrifuge is in a range of 4000 rpm to 6000 rpm, and a temperature of the centrifuge is in a range of 20° C. to 30° C.

In an embodiment, in the step S5, a temperature of the supercritical carbon dioxide extraction is in a range of 35° C. to 40° C., and a pressure of the supercritical carbon dioxide extraction is in a range of 7.08 megapascals (MPa) to 7.88 MPa.

In an embodiment, in the step S201, a concentration of the propanol solution is 40%.

Compared to the related art, the beneficial effects of the disclosure are as follows.

1. The method is simple and conducive to industrial production, significantly reducing production costs and providing a clear competitive advantage in the industry.

2. The disclosure achieves debitterizing wheat protein peptide residue and improves its flavor by adding the debitterizing modified solution and modified flavor protease, with remarkable debitterizing effects. The added microbial strains effectively enhance the debitterizing efficiency.

3. The composite flavor protease, through precise hydrolysis, adjusts the molecular weight and peptide chain structure of the hydrolysis products, reducing the formation of bitter peptides. Meanwhile, the action of exopeptidases ensures that any bitter peptides generated are promptly degraded, preventing their residual presence in the final product.

### BRIEF DESCRIPTION OF DRAWINGS

FIG. 1 illustrates a process flow diagram of a method for debitterizing wheat protein peptide residue in the disclosure.

FIG. 2 illustrates a bitterness level curve of a debitterized peptide residue product obtained after the debitterizing in the disclosure.

### DETAILED DESCRIPTION OF EMBODIMENTS

The following will provide a clear and complete description of the disclosure in conjunction with the embodiments in the disclosure. Apparently, the described embodiments are only a part of the embodiments of the disclosure, and not all of them. Based on the embodiments of the disclosure, all other embodiments obtained by those skilled in the art without creative labor are within the scope of protection of the disclosure.

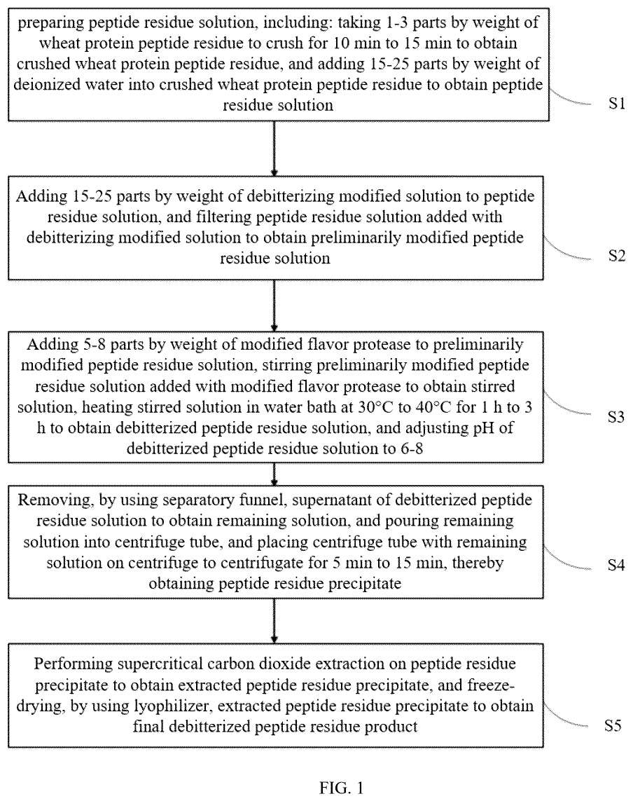

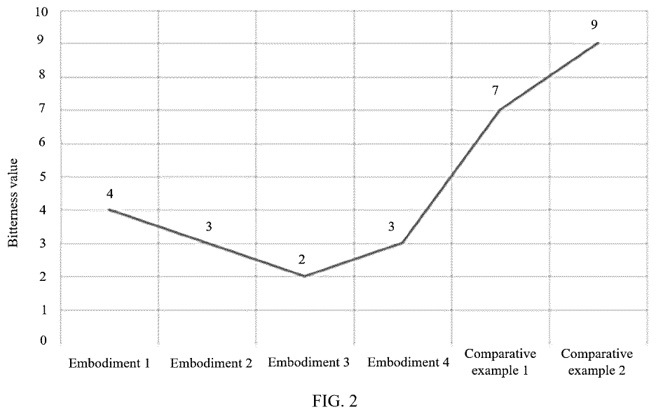

As shown in FIGS. 1-2, the embodiments of the disclosure are as follows.

### Embodiment 1

A method for debitterizing wheat protein peptide residue includes the following steps S1-S5.

In step S1, a peptide residue solution is prepared. 1 gram (g) of the wheat protein peptide residue is taken to crush for 10 min to obtain crushed wheat protein peptide residue, and 150 milliliters (mL) of deionized water are added into the crushed wheat protein peptide residue to obtain the peptide residue solution.

In step S2, a debitterizing modified solution is prepared, including the following steps S201-S202.

In step S201, 0.5 g of yeast, 0.1 g of active dry brewing yeast, 80 mL of deionized water, and 20 mL of propanol solution with a concentration of 40% are mixed and stirred to obtain a first mixture, and 0.2 g of sodium dihydrogen phosphate is added into the first mixture to obtain a primary modified solution.

In step S202, 4 g of activated carbon are added to the primary modified solution to stir thoroughly, thereby obtaining the debitterizing modified solution.

In the step S2, the debitterizing modified solution is added to the peptide residue solution obtained from S1, and the peptide residue solution added with the debitterizing modified solution is filtered to obtain a preliminarily modified peptide residue solution.

In step S3, modified flavor protease is prepared, including the following steps S301-S303.

In step S301, Lactiplantibacillus plantarum is inoculated onto a first culture medium, and the first culture medium inoculated with the Lactiplantibacillus plantarum is incubated in a constant temperature incubator at 35° C. for 10 h to obtain incubated Lactiplantibacillus plantarum. The incubated Lactiplantibacillus plantarum is selected from a slant of the first culture medium, and the incubated Lactiplantibacillus plantarum is inoculated into a sterilized MRS liquid culture medium to incubate in the constant temperature incubator at 35° C. for 10 h to obtain a Lactiplantibacillus plantarum seed solution.

In step S302, Bacillus subtilis is inoculated onto a second culture medium, and the second culture medium inoculated with the Bacillus subtilis is incubated in the constant temperature incubator at 35° C. for 10 h. A loop of bacterial lawn of the Bacillus subtilis is selected from a slant of the second culture medium with incubated Bacillus subtilis, the loop of bacterial lawn of the Bacillus subtilis is inoculated onto a shake flask seed culture medium for shaking culture with a rotational speed of 150 rpm at 35° C. for 10 h to obtain a Bacillus subtilis seed solution.

In step S303, 10 g of composite flavor protease, 1.5 g of the Lactiplantibacillus plantarum seed solution, and 1 g of the Bacillus subtilis seed solution are mixed to obtain a second mixture, and the second mixture is placed in a constant temperature shaker for fermentation culture with a rotational speed of 150 rpm at 35° C. for 8 h to obtain the modified flavor protease.

In the step S3, 5 g of the modified flavor protease are added to the preliminarily modified peptide residue solution. The preliminarily modified peptide residue solution added with the modified flavor protease is stirred with a rotational speed of 350 rpm for 20 min to obtain a stirred solution. The stirred solution is heated in a water bath at 30° C. for 1 h to obtain a debitterized peptide residue solution. A pH of the debitterized peptide residue solution is adjusted to 6.

In step S4, a supernatant of the debitterized peptide residue solution is removed by using a separatory funnel to obtain a remaining solution, the remaining solution is poured into a centrifuge tube, and the centrifuge tube with the remaining solution is placed on a centrifuge to centrifugate with a rotational speed of 4000 rpm at 20° C. for 5 min, thereby obtaining a peptide residue precipitate.

In step S5, supercritical carbon dioxide extraction is performed on the peptide residue precipitate with a pressure of 7.08 MPa at 35° C. to obtain an extracted peptide residue precipitate, and the extracted peptide residue precipitate is freeze-dried by using a lyophilizer to obtain a final debitterized peptide residue product.

### Embodiment 2

A method for debitterizing wheat protein peptide residue includes the following steps S1-S5.

In step S1, a peptide residue solution is prepared. 3 g of the wheat protein peptide residue are taken to crush for 15 min to obtain crushed wheat protein peptide residue, and 250 mL of deionized water are added into the crushed wheat protein peptide residue to obtain the peptide residue solution.

In step S2, a debitterizing modified solution is prepared, including the following steps S201-S202.

In the step S201, 1 g of yeast, 0.2 g of active dry brewing yeast, 100 mL of deionized water, and 30 mL of a propanol solution with a concentration of 40% are mixed and stirred to obtain a first mixture, and 1 g of sodium dihydrogen phosphate is added into the first mixture to obtain a primary modified solution.

In the step S202, 5 g of activated carbon are added to the primary modified solution to stir thoroughly, thereby obtaining the debitterizing modified solution.

In the step S2, the debitterizing modified solution is added to the peptide residue solution obtained from S1, the peptide residue solution added with the debitterizing modified solution is filtered to obtain a preliminarily modified peptide residue solution.

In the step S3, a modified flavor protease is prepared, including the following steps S301-S303.

In the step S301, Lactiplantibacillus plantarum is inoculated onto a first culture medium, and the first culture medium inoculated with the Lactiplantibacillus plantarum is incubated in a constant temperature incubator at 37° C. for 12 h to obtain incubated Lactiplantibacillus plantarum. The incubated Lactiplantibacillus plantarum is selected from a slant of the first culture medium, and the incubated Lactiplantibacillus plantarum is inoculated into a sterilized MRS liquid culture medium to incubate in the constant temperature incubator at 37° C. for 12 h to obtain a Lactiplantibacillus plantarum seed solution.

In the step S302, Bacillus subtilis is inoculated onto a second culture medium and the second culture medium inoculated with the Bacillus subtilis is incubated in the constant temperature incubator at 37° C. for 12 h. A loop of bacterial lawn of the Bacillus subtilis is selected from a slant of the second culture medium with incubated Bacillus subtilis, the loop of bacterial lawn of the Bacillus subtilis is inoculated onto a shake flask seed culture medium for shaking culture with a rotational speed of 150 rpm at 37° C. for 12 h to obtain a Bacillus subtilis seed solution.

In the step S303, 15 g of composite flavor protease, 4 g of the Lactiplantibacillus plantarum seed solution, and 3 g of the Bacillus subtilis seed solution are mixed to obtain a second mixture, and the second mixture is placed in a constant temperature shaker for fermentation culture with a rotational speed of 200 rpm at 37° C. for 10 h to obtain the modified flavor protease.

In the step S3, 8 g of the modified flavor protease are added to the preliminarily modified peptide residue solution. The preliminarily modified peptide residue solution added with the modified flavor protease is stirred with a rotational speed of 450 rpm for 25 min to obtain a stirred solution. The stirred solution is heated in a water bath at 40° C. for 3 h to obtain a debitterized peptide residue solution. A pH of the debitterized peptide residue solution is adjusted to 8.

In step S4, a supernatant of the debitterized peptide residue solution is removed by using a separatory funnel to obtain a remaining solution, the remaining solution is poured into a centrifuge tube, and the centrifuge tube with the remaining solution is placed on a centrifuge to centrifugate with a rotational speed of 6000 rpm at 30° C. for 15 min, thereby obtaining a peptide residue precipitate.

In step S5, supercritical carbon dioxide extraction is performed on the peptide residue precipitate with a pressure of 7.88 MPa at 40° C. to obtain an extracted peptide residue precipitate, and the extracted peptide residue precipitate is freeze-dried by using a lyophilizer to obtain a final debitterized peptide residue product.

### Embodiment 3

A method for debitterizing wheat protein peptide residue includes the following steps S1-S5.

In step S1, a peptide residue solution is prepared. 2 g of the wheat protein peptide residue are taken to crush for 12 min to obtain crushed wheat protein peptide residue, and 200 mL of deionized water are added into the crushed wheat protein peptide residue to obtain the peptide residue solution.

In step S2, a debitterizing modified solution is prepared, including the following steps S201-S202.

In the step S201, 0.7 g of yeast, 0.15 g of active dry brewing yeast, 85 mL of deionized water, and 25 mL of a propanol solution with a concentration of 40% are mixed and stirred to obtain a first mixture, and 0.4 g of sodium dihydrogen phosphate is added into the first mixture to obtain a primary modified solution.

In the step S202, 4.4 g of activated carbon are added to the primary modified solution to stir thoroughly, thereby obtaining the debitterizing modified solution.

In the step S2, the debitterizing modified solution is added to the peptide residue solution obtained from S1, the peptide residue solution added with the debitterizing modified solution is filtered to obtain a preliminarily modified peptide residue solution.

In the step S3, a modified flavor protease is prepared, including the following steps S301-S303.

In the step S301, Lactiplantibacillus plantarum is inoculated onto a first culture medium, and the first culture medium inoculated with the Lactiplantibacillus plantarum is incubated in a constant temperature incubator at 36° C. for 11 h to obtain incubated Lactiplantibacillus plantarum. The incubated Lactiplantibacillus plantarum is selected from a slant of the first culture medium, and the incubated Lactiplantibacillus plantarum is inoculated into a sterilized MRS liquid culture medium to incubate in the constant temperature incubator at 36° C. for 11 h to obtain a Lactiplantibacillus plantarum seed solution.

In the step S302, Bacillus subtilis is inoculated onto a second culture medium and the second culture medium inoculated with the Bacillus subtilis is incubated in the constant temperature incubator at 36° C. for 11 h. A loop of bacterial lawn of the Bacillus subtilis is selected from a slant of the second culture medium with incubated Bacillus subtilis, the loop of bacterial lawn of the Bacillus subtilis is inoculated onto a shake flask seed culture medium for shaking culture with a rotational speed of 130 rpm at 36° C. for 11 h to obtain a Bacillus subtilis seed solution.

In the step S303, 12 g of composite flavor protease, 2 g of the Lactiplantibacillus plantarum seed solution, and 2 g of the Bacillus subtilis seed solution are mixed to obtain a second mixture, and the second mixture is placed in a constant temperature shaker for fermentation culture with a rotational speed of 170 rpm at 36° C. for 9 h to obtain the modified flavor protease.

In the step S3, 6 g of the modified flavor protease are added to the preliminarily modified peptide residue solution. The preliminarily modified peptide residue solution added with the modified flavor protease is stirred with a rotational speed of 400 rpm for 22 min to obtain a stirred solution. The stirred solution is heated in a water bath at 35° C. for 2 h to obtain a debitterized peptide residue solution. A pH of the debitterized peptide residue solution is adjusted to 7.

In step S4, a supernatant of the debitterized peptide residue solution is removed by using a separatory funnel to obtain a remaining solution, the remaining solution is poured into a centrifuge tube, and the centrifuge tube with the remaining solution is placed on a centrifuge to centrifugate with a rotational speed of 5000 rpm at 25° C. for 8 min, thereby obtaining a peptide residue precipitate.

In step S5, supercritical carbon dioxide extraction is performed on the peptide residue precipitate with a pressure of 7.28 MPa at 36° C. to obtain an extracted peptide residue precipitate, and the extracted peptide residue precipitate is freeze-dried by using a lyophilizer to obtain a final debitterized peptide residue product.

### Embodiment 4

A method for debitterizing wheat protein peptide residue includes the following steps S1-S5.

In step S1, a peptide residue solution is prepared. 2.5 g of the wheat protein peptide residue are taken to crush for 14 min to obtain crushed wheat protein peptide residue, and 220 mL of deionized water are added into the crushed wheat protein peptide residue to obtain the peptide residue solution.

In step S2, a debitterizing modified solution is prepared, including the following steps S201-S202.

In the step S201, 0.9 g of yeast, 0.18 g of active dry brewing yeast, 95 mL of deionized water, and 28 mL of a propanol solution with a concentration of 40% are mixed and stirred to obtain a first mixture, and 0.8 g of sodium dihydrogen phosphate is added into the first mixture to obtain a primary modified solution.

In the step S202, 4.7 g of activated carbon are added to the primary modified solution to stir thoroughly, thereby obtaining the debitterizing modified solution.

In the step S2, the debitterizing modified solution is added to the peptide residue solution obtained from S1, the peptide residue solution added with the debitterizing modified solution is filtered to obtain a preliminarily modified peptide residue solution.

In the step S3, a modified flavor protease is prepared, including the following steps S301-S303.

In the step S301, Lactiplantibacillus plantarum is inoculated onto a first culture medium, and the first culture medium inoculated with the Lactiplantibacillus plantarum is incubated in a constant temperature incubator at 36° C. for 11 h to obtain incubated Lactiplantibacillus plantarum. The incubated Lactiplantibacillus plantarum is selected from a slant of the first culture medium, and the incubated Lactiplantibacillus plantarum is inoculated into a sterilized MRS liquid culture medium to incubate in the constant temperature incubator at 36° C. for 11 h to obtain a Lactiplantibacillus plantarum seed solution.

In the step S302, Bacillus subtilis is inoculated onto a second culture medium and the second culture medium inoculated with the Bacillus subtilis is incubated in the constant temperature incubator at 36° C. for 11 h. A loop of bacterial lawn of the Bacillus subtilis is selected from a slant of the second culture medium with incubated Bacillus subtilis, the loop of bacterial lawn of the Bacillus subtilis is inoculated onto a shake flask seed culture medium for shaking culture with a rotational speed of 140 rpm at 36° C. for 11 h to obtain a Bacillus subtilis seed solution.

In the step S303, 14 g of composite flavor protease, 3 g of the Lactiplantibacillus plantarum seed solution, and 2.5 g of the Bacillus subtilis seed solution are mixed to obtain a second mixture, and the second mixture is placed in a constant temperature shaker for fermentation culture with a rotational speed of 180 rpm at 36° C. for 9 h to obtain the modified flavor protease.

In the step S3, 7 g of the modified flavor protease are added to the preliminarily modified peptide residue solution. The preliminarily modified peptide residue solution added with the modified flavor protease is stirred with a rotational speed of 430 rpm for 24 min to obtain a stirred solution. The stirred solution is heated in a water bath at 38° C. for 2.5 h to obtain a debitterized peptide residue solution. A pH of the debitterized peptide residue solution is adjusted to 7.

In step S4, a supernatant of the debitterized peptide residue solution is removed by using a separatory funnel to obtain a remaining solution, the remaining solution is poured into a centrifuge tube, and the centrifuge tube with the remaining solution is placed on a centrifuge to centrifugate with a rotational speed of 5500 rpm at 28° C. for 13 min, thereby obtaining a peptide residue precipitate.

In step S5, supercritical carbon dioxide extraction is performed on the peptide residue precipitate with a pressure of 7.58 MPa at 38° C. to obtain an extracted peptide residue precipitate, and the extracted peptide residue precipitate is freeze-dried by using a lyophilizer to obtain a final debitterized peptide residue product.

### Comparative Example 1

A method for debitterizing wheat protein peptide residue includes the following steps S1-S5.

In step S1, a peptide residue solution is prepared. 1 g of the wheat protein peptide residue are taken to crush for 10 min to obtain crushed wheat protein peptide residue, and 150 mL of deionized water are added into the crushed wheat protein peptide residue to obtain the peptide residue solution.

In step S2, a debitterizing modified solution is prepared, including the following steps S201-S202.

In the step S201, Lactiplantibacillus plantarum is inoculated onto a first culture medium, and the first culture medium inoculated with the Lactiplantibacillus plantarum is incubated in a constant temperature incubator at 35° C. for 10 h to obtain incubated Lactiplantibacillus plantarum. The incubated Lactiplantibacillus plantarum is selected from a slant of the first culture medium, and the incubated Lactiplantibacillus plantarum is inoculated into a sterilized MRS liquid culture medium to incubate in the constant temperature incubator at 35° C. for 10 h to obtain a Lactiplantibacillus plantarum seed solution.

In the step S302, Bacillus subtilis is inoculated onto a second culture medium and the second culture medium inoculated with the Bacillus subtilis is incubated in the constant temperature incubator at 35° C. for 10 h. A loop of bacterial lawn of the Bacillus subtilis is selected from a slant of the second culture medium with incubated Bacillus subtilis, the loop of bacterial lawn of the Bacillus subtilis is inoculated onto a shake flask seed culture medium for shaking culture with a rotational speed of 120 rpm at 35° C. for 10 h to obtain a Bacillus subtilis seed solution.

In the step S303, 10 g of composite flavor protease, 1.5 g of the Lactiplantibacillus plantarum seed solution, and 1 g of the Bacillus subtilis seed solution are mixed to obtain a second mixture, and the second mixture is placed in a constant temperature shaker for fermentation culture with a rotational speed of 150 rpm at 35° C. for 8 h to obtain the modified flavor protease.

In the step S3, 5 g of the modified flavor protease are added to the preliminarily modified peptide residue solution. The preliminarily modified peptide residue solution added with the modified flavor protease is stirred with a rotational speed of 350 rpm for 20 min to obtain a stirred solution. The stirred solution is heated in a water bath at 30° C. for 1 h to obtain a debitterized peptide residue solution. A pH of the debitterized peptide residue solution is adjusted to 6.

In step S4, a supernatant of the debitterized peptide residue solution is removed by using a separatory funnel to obtain a remaining solution, the remaining solution is poured into a centrifuge tube, and the centrifuge tube with the remaining solution is placed on a centrifuge to centrifugate with a rotational speed of 4000 rpm at 20° C. for 5 min, thereby obtaining a peptide residue precipitate.

In step S5, supercritical carbon dioxide extraction is performed on the peptide residue precipitate with a pressure of 7.08 MPa at 35° C. to obtain an extracted peptide residue precipitate, and the extracted peptide residue precipitate is freeze-dried by using a lyophilizer to obtain a final debitterized peptide residue product.

### Comparative Example 2

A method for debitterizing wheat protein peptide residue includes the following steps S1-S5.

In the step S1, a peptide residue solution is prepared: 1 g of the wheat protein peptide residue are taken to crush for 10 min, and then 150 mL of deionized water are added into the crushed wheat protein peptide residue to prepare the peptide residue solution. In step S1, a peptide residue solution is prepared. 1 g of the wheat protein peptide residue are taken to crush for 10 min to obtain crushed wheat protein peptide residue, and 150 mL of deionized water are added into the crushed wheat protein peptide residue to obtain the peptide residue solution.

In step S2, a debitterizing modified solution is prepared, including the following steps S201-S202.

In the step S201, 0.5 g of yeast, 0.1 g of active dry brewing yeast, 80 mL of deionized water, and 20 mL of a propanol solution with a concentration of 40% are mixed and stirred to obtain a first mixture, and 0.2 g of sodium dihydrogen phosphate is added into the first mixture to obtain a primary modified solution.

In the step S202, 4 g of activated carbon are added to the primary modified solution to stir thoroughly, thereby obtaining the debitterizing modified solution.

In the step S3, the debitterizing modified solution is added to the peptide residue solution obtained from S1, the peptide residue solution added with the debitterizing modified solution is filtered to obtain a preliminarily modified peptide residue solution.

In step S4, supercritical carbon dioxide extraction is performed on the peptide residue precipitate with a pressure of 7.08 MPa at 35° C. to obtain an extracted peptide residue precipitate, and the extracted peptide residue precipitate is freeze-dried by using a lyophilizer to obtain a final debitterized peptide residue product.

### Performance Testing

Taste dilution analysis is conducted on the final debitterized peptide residue products obtained from the embodiments 1˜4 and the comparative examples 1-2 in accordance with the standard GB31611-2023, “National Food Safety Standard for Plant Protein Peptides for Food Processing”. The wheat protein peptide residue samples are dissolved in a certain amount of water to prepare solutions of specific concentrations. The sample solutions are gradually diluted by increasing the volume of water until the bitterness could no longer be perceived. Specific data are provided for analysis, where “+” indicates the detection of bitterness, and “−” indicates no detection of bitterness. The test results are shown in Table 1 below:

TABLE 1

| | Bitter taste | Bitter taste | Bitter taste | Bitter taste |
|---|---|---|---|---|
| | perception | perception | perception | perception |
| | after adding | after adding | after adding | after adding |
| | 100 mL of | 200 mL of | 300 mL of | 400 mL of |
| | water | water | water | water |
| Embodiment 1 | + | + | + | − |
| Embodiment 2 | + | + | − | − |
| Embodiment 3 | + | − | − | − |
| Embodiment 4 | + | + | − | − |
| Comparative | + | + | + | + |
| example 1 | | | | |
| Comparative | + | + | + | + |
| example 2 | | | | |

Comparative example 1 lacks the debitterizing modified solution compared to the embodiment 1, and comparative example 2 lacks the modified flavor protease compared to embodiment 1. From the test results of bitterness values, the debitterizing effect of embodiment 3 is the best. By examining the different levels of bitterness perception achieved by adding 100 mL to 400 mL of water, the bitterness perception after adding 300 ml of water can be considered as a dividing line for categorizing bitterness levels. Based on this, embodiment 1 is set as level 4, embodiment 2 as level 3, embodiment 3 as level 2, embodiment 4 as level 3, comparative example 1 as level 7, and comparative example 2 as level 9. A bitterness level curve is drawn, as shown in FIG. 2. The bitterness level curve clearly shows that the debitterizing effects of embodiments 1-4 are significantly greater than those of comparative examples 1-2. Therefore, both the debitterizing modification solution and the modified flavor protease can achieve a noticeable debitterizing effect, and they complement each other to achieve the optimal technical effect.

Although the embodiments of the disclosure have been shown and described, it will be understood by those skilled in the art that various changes, modifications, substitutions, and variations can be made to these embodiments without departing from the principles and spirit of the disclosure. The scope of the disclosure is limited by the appending claims and their equivalents.

What is claimed is:

1. A method for debitterizing wheat protein peptide residue, comprising:
S1, preparing a peptide residue solution, comprising: taking 1-3 parts by weight of the wheat protein peptide residue to crush for 10 minutes (min) to 15 min to obtain crushed wheat protein peptide residue, and adding 15-25 parts by weight of deionized water into the crushed wheat protein peptide residue to obtain the peptide residue solution;
S2, adding 15-25 parts by weight of debitterizing modified solution to the peptide residue solution, and filtering the peptide residue solution added with the debitterizing modified solution to obtain a preliminarily modified peptide residue solution;
S3, adding 5-8 parts by weight of modified flavor protease to the preliminarily modified peptide residue solution, stirring the preliminarily modified peptide residue solution added with the modified flavor protease to obtain a stirred solution, heating the stirred solution in a water bath at 30 Celsius degrees (° C.) to 40° C. for 1 hour (h) to 3 h to obtain a debitterized peptide residue solution, and adjusting a potential of hydrogen (pH) of the debitterized peptide residue solution to 6-8;
S4, removing, by using a separatory funnel, a supernatant of the debitterized peptide residue solution to obtain a remaining solution, and pouring the remaining solution into a centrifuge tube, and placing the centrifuge tube with the remaining solution on a centrifuge to centrifugate for 5 min to 15 min, thereby obtaining a peptide residue precipitate; and
S5, performing supercritical carbon dioxide extraction on the peptide residue precipitate to obtain an extracted peptide residue precipitate, and freeze-drying, by using a lyophilizer, the extracted peptide residue precipitate to obtain a final debitterized peptide residue product;
wherein a preparation method of the debitterizing modified solution comprises:
S201, mixing and stirring 0.5-1 parts by weight of yeast, 0.1-0.2 parts by weight of active dry brewing yeast, 8-10 parts by weight of deionized water, and 2-3 parts by weight of propanol solution to obtain a first mixture, and adding 0.2-1 parts by weight of sodium dihydrogen phosphate into the first mixture to obtain a primary modified solution; and
S202, adding 4-5 parts by weight of activated carbon to the primary modified solution to stir thoroughly, thereby obtaining the debitterizing modified solution.

2. The method for debitterizing the wheat protein peptide residue as claimed in claim 1, wherein, in step S3, a preparation method of the modified flavor protease comprises:
S301, inoculating Lactiplantibacillus plantarum onto a first culture medium, and incubating the first culture medium inoculated with the Lactiplantibacillus plantarum in a constant temperature incubator at 35° C. to 37° C. for 10 h to 12 h to obtain incubated Lactiplantibacillus plantarum; and selecting the incubated Lactiplantibacillus plantarum from a slant of the first culture medium, and inoculating the incubated Lactiplantibacillus plantarum into a sterilized De Man, Rogosa and Sharpe (MRS) liquid culture medium to incubate in the constant temperature incubator at 35° C. to 37° C. for 10 h to 12 h to obtain a Lactiplantibacillus plantarum seed solution;
S302, inoculating Bacillus subtilis onto a second culture medium, and incubating the second culture medium inoculated with the Bacillus subtilis in the constant temperature incubator at 35° C. to 37° C. for 10 h to 12 h; and selecting a loop of bacterial lawn of the Bacillus subtilis from a slant of the second culture medium with incubated Bacillus subtilis, inoculating the loop of bacterial lawn of the Bacillus subtilis onto a shake flask seed culture medium for shaking culture at 35° C. to 37° C. for 10 h to 12 h to obtain a Bacillus subtilis seed solution; and
S303, mixing 10-15 parts by weight of composite flavor protease, 1.5-4 parts by weight of the Lactiplantibacillus plantarum seed solution, and 1-3 parts by weight of the Bacillus subtilis seed solution to obtain a second mixture, and placing the second mixture in a constant temperature shaker for fermentation culture for 8 h to 10 h to obtain the modified flavor protease.

3. The method for debitterizing the wheat protein peptide residue as claimed in claim 2, wherein in the step S301, the first culture medium is a MRS solid agarslantculture-medium.

4. The method for debitterizing the wheat protein peptide residue as claimed in claim 2, wherein in the step S302, the second culture medium is a Luria-Bertani (LB) solid agarslantculture-medium.

5. The method for debitterizing the wheat protein peptide residue as claimed in claim 2, wherein in the step S302, a rotational speed of the shaking culture is in a range of 120 revolutions per minute (rpm) to 150 rpm.

6. The method for debitterizing the wheat protein peptide residue as claimed in claim 2, wherein in the step S303, a temperature of the constant temperature shaker is in a range of 35° C. to 37° C., and a rotational speed of the constant temperature shaker is in a range of 150 rpm to 200 rpm.

7. The method for debitterizing the wheat protein peptide residue as claimed in claim 1, wherein in the step S3, a time of the stirring is in a range of 20 min to 25 min, and a rotational speed of the stirring is in a range of 350 rpm to 450 rpm.

8. The method for debitterizing the wheat protein peptide residue as claimed in claim 1, wherein in the step S4, a rotational speed of the centrifuge is in a range of 4000 rpm to 6000 rpm, and a temperature of the centrifuge is in a range of 20° C. to 30° C.

9. The method for debitterizing the wheat protein peptide residue as claimed in claim 1, wherein in the step S5, a temperature of the supercritical carbon dioxide extraction is in a range of 35° C. to 40° C., and a pressure of the supercritical carbon dioxide extraction is in a range of 7.08 megapascals (MPa) to 7.88 MPa.

10. The method for debitterizing the wheat protein peptide residue as claimed in claim 1, wherein in the step S201, a concentration of the propanol solution is 40%.
